(19) United States
(12) Patent Application Publication
(10) Pub. No.: US 2009/0315223 A1
(43) Pub. Date: Dec. 24, 2009

(54) TEMPLATE AND PATTERN FORMING METHOD

(76) Inventors: Ikuo Yoneda, Yokohama-shi (JP); Shinji Mikami, Kawasaki-shi (JP); Takumi Ota, Yokohama-shi (JP); Tetsuro Nakasugi, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/483,705

(22) Filed: Jun. 12, 2009

(30) Foreign Application Priority Data
Jun. 13, 2008 (JP) 2008-155611

(51) Int. Cl. B29C 35/08; B29C 59/02

(52) U.S. Cl. 264/402; 425/385

(57) ABSTRACT

A template includes a substrate, an element pattern formed on a surface of the substrate, and a light absorbing portion formed on or inside the substrate.

### CROSS-REFERENCE TO RELATED APPLICATIONS

This application is based upon and claims the benefit of priority from prior Japanese Patent Application No. 2008-155611, filed Jun. 13, 2008, the entire contents of which are incorporated herein by reference.

### BACKGROUND OF THE INVENTION

1. Field of the Invention

The present invention relates to a template and a pattern forming method.

2. Description of the Related Art

A nano-imprint method has been proposed which is a pattern transfer technique for a process of manufacturing a semiconductor device (for example, Jpn. Pat. Appln. KOKAI Publication No. 2000-194142). In the nano-imprint method, a template (mold) with an element pattern is pressed against a nano-imprint material layer to transfer the element pattern to the nano-imprint material layer.

However, a high-accuracy element pattern cannot be easily formed on the template. Ensuring the positional accuracy of the element pattern is difficult. Thus, ensuring the positional accuracy of the element pattern transferred to the nano-imprint material layer is difficult.

### BRIEF SUMMARY OF THE INVENTION

A template according to a first aspect of the present invention comprising: a substrate; an element pattern formed on a surface of the substrate; and a light absorbing portion formed on or inside the substrate.

A pattern forming method according to a second aspect of the present invention comprising: preparing the template; pressing the template against a nano-imprint material layer to transfer the element pattern to the nano-imprint material layer, wherein before or during transferring the element pattern to the nano-imprint material layer, the light absorbing portion is irradiated with irradiation light to thermally expand the template to displace a position of the element pattern.

### BRIEF DESCRIPTION OF THE SEVERAL VIEWS OF THE DRAWING

FIG. 1 is a sectional view schematically showing the configuration of a template according to a first embodiment of the present invention;

FIG. 2 is an enlarged diagram showing a part of the template shown in FIG. 1;

FIG. 3 is a plan view schematically showing the configuration of the template according to the first embodiment of the present invention;

FIG. 4 is a sectional view schematically showing the configuration of a template according to a modification of the first embodiment of the present invention;

FIG. 5 is a flowchart showing an example of a template producing method and a pattern forming method according to the first embodiment of the present invention;

FIG. 6 is a diagram showing imprinting according to the first embodiment of the present invention;

FIG. 7 is a flowchart showing another example of the template producing method and pattern forming method according to the first embodiment of the present invention;

FIG. 8 is a sectional view schematically showing the configuration of a template according to a second embodiment of the present invention;

FIG. 9 is a plan view schematically showing the configuration of the template according to the second embodiment of the present invention;

FIG. 10 is a sectional view schematically showing the configuration of a template according to a modification of the second embodiment of the present invention;

FIG. 11 is a flowchart showing a template producing method and a pattern forming method according to the second embodiment of the present invention;

FIG. 12 is a diagram showing imprinting according to the second embodiment of the present invention;

FIG. 13 is a sectional view schematically showing the configuration of a template according to a first example of a third embodiment of the present invention;

FIG. 14 is a sectional view schematically showing the configuration of a template according to a second example of the third embodiment of the present invention;

FIG. 15 is a sectional view schematically showing the configuration of a template according to a third example of the third embodiment of the present invention;

FIG. 16 is a sectional view schematically showing the configuration of a template according to the fourth embodiment of the present invention;

FIG. 17 is a diagram schematically showing how alignment is performed according to the fourth embodiment of the present invention; and

FIG. 18 is a sectional view schematically showing the configuration of a template according to a modification of the fourth embodiment of the present invention.

### DETAILED DESCRIPTION OF THE INVENTION

Embodiments of the present invention will be described below with reference to the drawings.

### Embodiment 1

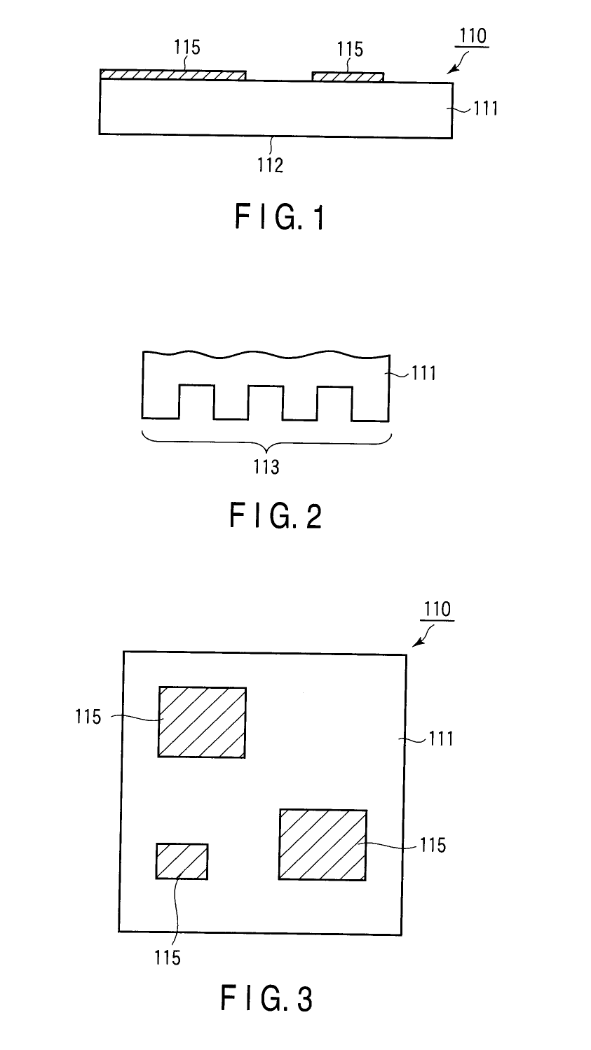

FIGS. 1 to 3 are diagrams schematically showing the configuration of a template (mold) used for a nano-imprint method according to a first embodiment of the present invention. FIG. 1 is a sectional view of the template. FIG. 2 is an enlarged diagram of a part of the template shown in FIG. 1. FIG. 3 is a plan view of the template.

The template 110 is composed of a transparent substrate 111 such as quartz glass. A nano-imprinting element pattern 113 is formed on the front surface (pattern formation surface 112) of the transparent substrate 111. Examples of the element pattern include a pattern for formation of a semiconductor device such as a transistor and a wiring pattern.

A light absorbing portion 115 is locally provided on the back surface of the transparent substrate 111. The light absorbing portion 115 absorbs light such as infrared rays better than the transparent substrate 111. For example, a metal film (for example, a CrN film) can be used as the light absorbing portion 115. However, an excessively thick metal film blocks ultraviolet light (UV light) used to photo-cure a nano-imprint material layer during imprinting. Thus, a thin metal film the thickness of which is adjusted is used as the light absorbing portion 115. When the light absorbing portion 115, which exhibits high light absorptivity, is irradiated with irradiation light such as infrared rays, the temperature of the light absorbing portion 115 and the vicinity of the light absorbing portion 115 increases, locally expanding the transparent substrate 111. Thus, the position of the element pattern 113 can be locally displaced, enabling the transfer position of the element pattern 113 to be corrected. This will be further described below.

When a nano-imprinting template is produced, certain factors may prevent the positional accuracy of the element pattern from being ensured. One of the factors is a rise in temperature during writing of the element pattern using electron beams. For example, the temperature rises sharply in areas in which the write pattern has a high occupancy ratio (pattern occupancy per unit area). Thus, in such areas, the element pattern is written at relatively high temperature. Consequently, in areas with high pattern occupancies, the element pattern is written with the template substrates locally expanded. After the writing, the substrate returns to the original state. As a result, the position of the element pattern actually formed deviates from that of the intended element pattern.

Thus, in the present embodiment, the light absorbing portion 115 is provided with the template 110 to locally raise the temperature of the transparent substrate 111. Thus, imprinting is performed with the transparent substrate 111 locally expanded. That is, the imprinting is performed in a thermally expanded state that is as close to that during the writing of the element pattern as possible. Specifically, the light absorbing portion 115 is locally provided based on the arrangement of the element pattern (particularly based on the pattern occupancy ratio of the element pattern). With this configuration, even if the position of the element pattern actually formed deviates from that of the intended element pattern, the imprinting can be performed with the element pattern displaced to the regular position (intended element pattern position). That is, the position of the element pattern can be corrected. This enables an increase in the positional accuracy of the element pattern transferred to the nano-imprint material layer.

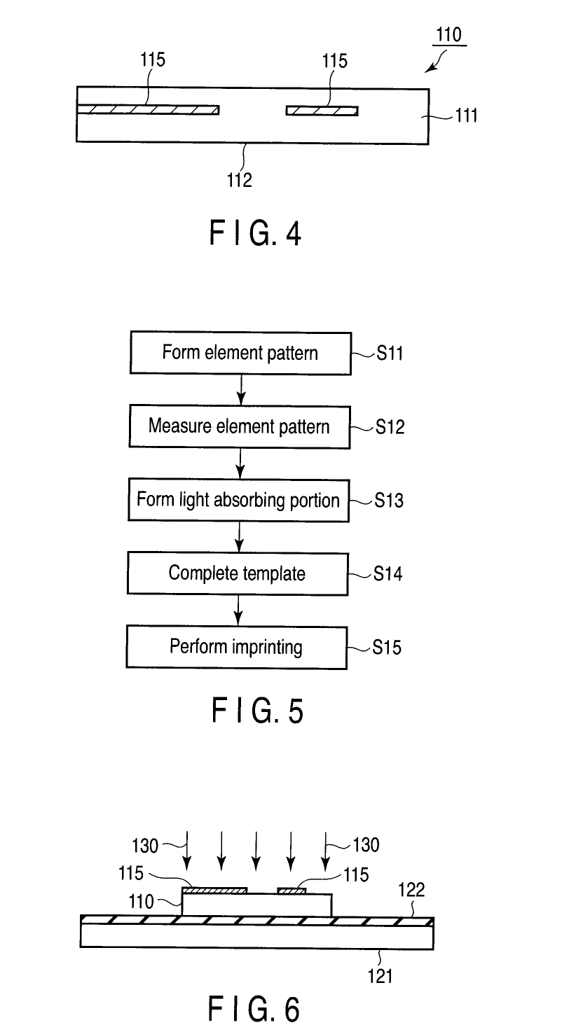

In the above-described example, the light absorbing portion 115 is provided on the back surface of the transparent substrate 111. However, as shown in FIG. 4, the light absorbing portion 115 may be provided in the transparent substrate 111. For example, the interior of the transparent substrate (glass substrate) 111 is irradiated with laser light to partly melt the transparent substrate 111. This enables a reduction in the transmittance of the part of the transparent substrate 111. Consequently, the light absorbing portion 115 can be formed in the transparent substrate 111.

Now, a template producing method and a pattern forming method according to the present embodiment will be described. FIG. 5 is a flowchart showing a first method.

First, a nano-imprinting element pattern is formed at the front surface (pattern formation surface) of a transparent substrate such as a glass substrate by electron beam writing (S11).

Then, the element pattern formed in step S11 is measured (S12). Based on measurement results, the element pattern is evaluated. Specifically, the distribution of pattern occupancy ratio of the element pattern (write pattern) at the pattern formation surface of the transparent substrate is determined.

Then, based on evaluation results obtained in step S12, a light absorbing portion is formed on the transparent substrate (S13). Specifically, based on the results of the evaluation of the pattern occupancy ratio, the light absorbing portion is formed at an appropriate position so that thermal expansion based on light absorption allows the element pattern of the template to be located as close to the regular position (intended element pattern portion) as possible. For example, the light absorbing portion is formed so as to have high occupancy ratio in areas with high pattern occupancy ratio.

Thus, as shown in FIGS. 1 to 3, the template 110 is completed with the light absorbing portion 115 appropriately located on the transparent substrate 111 (S14).

The template 110 produced as described above is used to perform optical nano-imprinting. That is, as shown in FIG. 6, the template 110 is pressed against a nano-imprint material layer 122 formed on a semiconductor substrate (semiconductor wafer) 121. The element pattern of the template 110 is thus transferred to the nano-imprint material layer 122. A photosensitive resin that is sensitive to ultraviolet light (UV light) is used as the nano-imprint material layer 122. The optical nano-imprinting performed in the present process will be specifically described below.

First, the template 110 is aligned with the semiconductor substrate 121 and then pressed against the nano-imprint material layer 122 on the semiconductor substrate 121. In this state, the entire area (entire surface) of the template 110 is irradiated with irradiation light 130 such as infrared light. Since the light absorbing portion is locally provided on the template 110, the temperature of the transparent substrate rises locally in the area in which the light absorbing portion is present. As a result, the transparent substrate 111 expands locally to displace the element pattern of the template 110 to the regular position (intended element pattern position). With the position of the element pattern of the template 110 displaced as described above, the nano-imprint material layer 122 is irradiated with ultraviolet light via the template 110 to cure the nano-imprint material layer 122. After the nano-imprint material layer 122 is cured, the template 110 is separated from the nano-imprint material layer 122. In this manner, the element pattern formed at the template 110 is transferred to the nano-imprint material layer 122.

The photo-curing ultraviolet light may be applied to the nano-imprint material layer 122 after the irradiation with the irradiation light 130 such as infrared light is completed or during the irradiation with the irradiation light. Alternatively, before the template 110 is pressed against the nano-imprint material layer 122, the nano-imprint material layer 122 may have been irradiated with the irradiation light 130 such as infrared light to raise the temperature of the light absorbing portion. In this case, after the irradiation with the irradiation light 130, the template 110 is pressed against the nano-imprint material layer 122. That is, the temperature of the light absorbing portion on the template 110 has only to be set to a desired value when the nano-imprint material layer 122 is irradiated with ultraviolet light and thus cured. Thus, in general, the light absorbing portion can be irradiated with the irradiation light 130 before or during the transfer of the element pattern to the nano-imprint material layer 122.

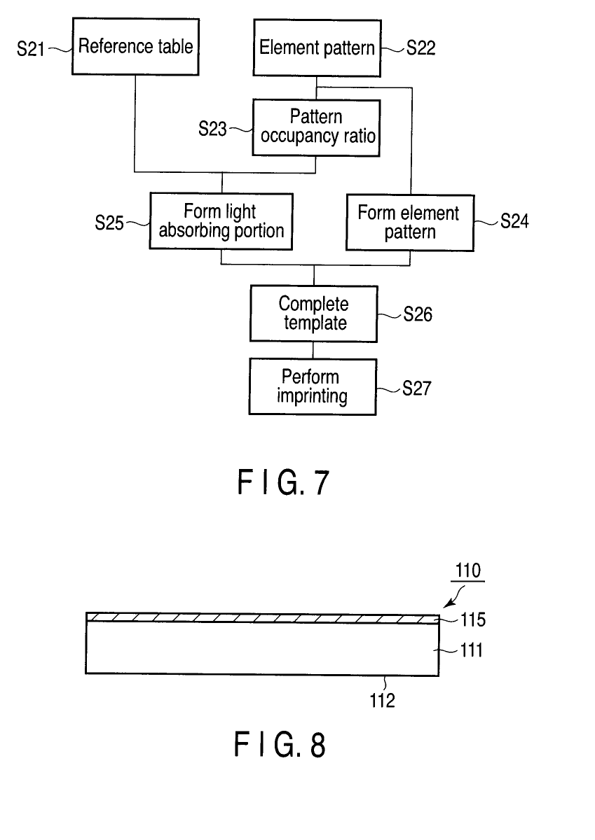

FIG. 7 is a flowchart showing a second method.

In the present method, the general correlation between the pattern occupancy ratio of a write pattern and the displacement of the pattern position (the displacement, from the intended regular element pattern position, of the element pattern formed on the template by electron beam writing) is predetermined and stored in a reference table (S21).

Then, pattern information on a nano-imprinting element pattern to be formed on the template is acquired (S22). Then, based on the pattern information acquired, the distribution of the pattern occupancy ratio of the element pattern (write pattern) on the pattern formation surface of the template is determined (S23).

Then, an element pattern is formed on the template based on the element pattern information obtained in step S22 (S24). A light absorbing portion is formed on the template based on the correlation information stored in the reference table in step S21 and the pattern occupancy ratio information obtained in step S23 (S25). That is, since the pattern occupancy ratio of the element pattern is determined in step S23, the displacement of the element pattern to be formed on the template can be determined by referencing the correlation stored in the reference table in step S21. As already described, the determined displacement of the element pattern allows the optimum location of the light absorbing portion for correcting the displacement to be determined. Thus, the light absorbing portion is formed at such an optimum location on the template.

Thus, as shown in FIGS. 1 to 3, the template 110 in which the light absorbing portion 115 is appropriately located on the transparent substrate 111 is completed (S26).

The template 110 thus produced is used to perform nano-imprinting (S27). The optical nano-imprinting performed in step S27 is similar to that performed in step S15 in the first method and will thus not be described in detail.

As described above, in the present embodiment, the light absorbing portion 115 is provided on the template 110 to allow the element pattern to be displaced to the appropriate position by means of thermal expansion based on the light absorption by the light absorbing portion 115. Thus, even if the position of the element pattern formed on the template deviates from that of the intended element pattern, the imprinting can be performed with the element pattern displaced to the appropriate position (intended element pattern position). As a result, the positional accuracy of the element pattern transferred to the nano-imprint material layer can be improved.

Furthermore, in the present embodiment, the light absorbing portion 115 is locally provided based on the arrangement of the element pattern 113. Thus, even when the entire area of the template 110 is irradiated with the irradiation light 130 as shown in FIG. 6, the appropriate area in the template 110 can be heated. Thus, the element pattern can be displaced to the appropriate position without the need to strictly control the irradiation position of the irradiation light 130.

### Embodiment 2

Now, a second embodiment of the present invention will be described. Basic matters in the second embodiment are similar to those in the first embodiment. Thus, the matters described in the first embodiment will not be described below.

FIGS. 8 and 9 are diagrams schematically showing the configuration of a template according to the present embodiment. FIG. 8 is a sectional view of the template. FIG. 9 is a plan view of the template.

As is the case with the first embodiment, the main body of the template 110 is composed of a transparent substrate 111 such as quartz glass. Such a nano-imprinting element pattern as shown in FIG. 2 for the first embodiment is formed at the front surface (pattern formation surface 112) of the transparent substrate 111.

In the present embodiment, a light absorbing portion 115 is formed all over the back surface of the transparent substrate 111. The light absorbing portion 115 absorbs light such as infrared rays better than the transparent substrate 111. A material and the like for the light absorbing portion 115 are similar to those in the first embodiment.

In the present embodiment, the light absorbing portion 115 is locally irradiated with irradiation light such as infrared rays. Thus, the temperature of the irradiation area and the vicinity thereof increases to locally expand the transparent substrate 111. As a result, as in the case of the first embodiment, the position of the element pattern can be locally displaced by thermal expansion based on light absorption. Even if the position of the element pattern actually formed on the template deviates from that of the intended element pattern, imprinting can be performed with the element pattern displaced to the regular position (intended element pattern position). That is, the position of the element pattern can be corrected. This enables an increase in the positional accuracy of the element pattern transferred to the nano-imprint material layer.

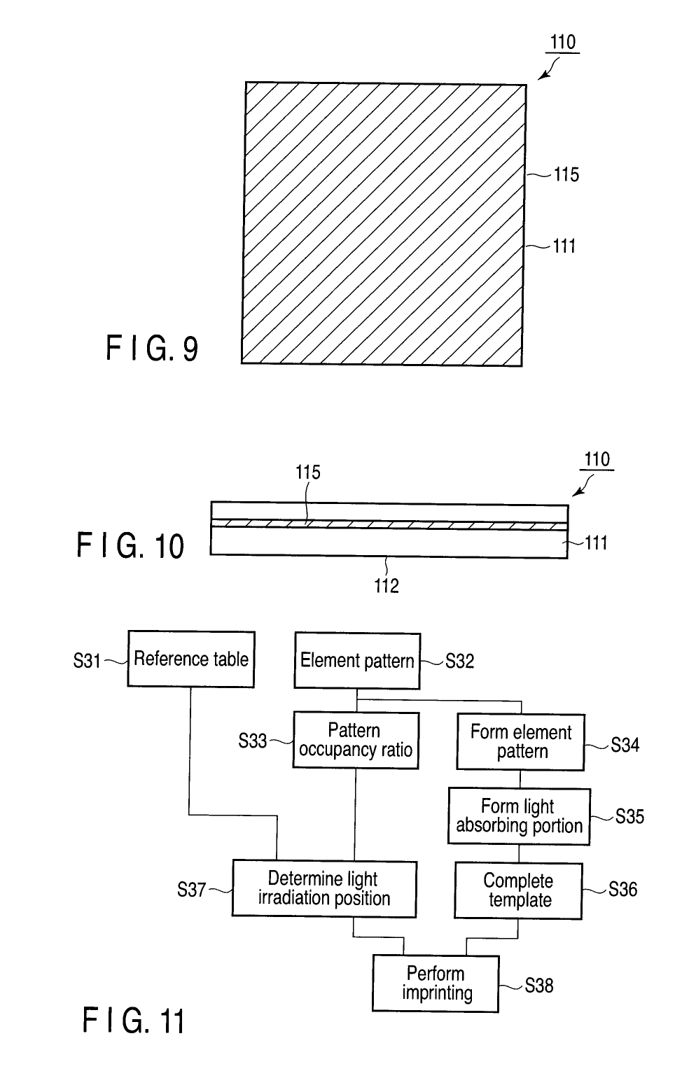

In the above-described example, the light absorbing portion 115 is provided on the back surface of the transparent substrate 111. However, as shown in FIG. 10, the light absorbing portion 115 may be provided in the transparent substrate 111. For example, the interior of the transparent substrate 111 is irradiated with laser light to partly melt the transparent substrate 111. This allows the light absorbing portion 115 to be formed in the transparent substrate 111.

Now, a template producing method and a pattern forming method according to the present embodiment will be described with reference to the flowchart shown in FIG. 11.

First, the general correlation between the pattern occupancy ratio of a write pattern and the displacement of the pattern position (the displacement, from the intended regular element pattern position, of the element pattern formed on the template by electron beam writing) is predetermined and stored in a reference table (S31).

Then, pattern information on a nano-imprinting element pattern to be formed on the template is acquired (S32). Then, based on the pattern information acquired, the distribution of the pattern occupancy ratio of the element pattern (write pattern) on the pattern formation surface of the template is determined (S33).

Then, an element pattern is formed on the front surface of the template based on the element pattern information obtained in step S22 (S34). A light absorbing portion is formed on the entire back surface of the template (S35). Thus, as shown in FIGS. 8 and 9, the template 110 having the light absorbing portion 115 formed all over the back surface of the transparent substrate 111 is completed (S36).

Before nano-imprinting is performed, the irradiation position (irradiation area) of irradiation light such as infrared rays is predetermined on the basis of the correlation information stored in the reference table in step S31 and the pattern occupancy ratio information obtained in step S33 (S37). That is, since the pattern occupancy ratio of the element pattern is determined in step S33, the displacement of the element pattern to be formed on the template can be determined by referencing the correlation stored in the reference table in step S31. As appreciated from the above description, the determined displacement of the element pattern allows the optimum light irradiation position for correcting the displacement to be determined. Thus, such an optimum light irradiation position is predetermined.

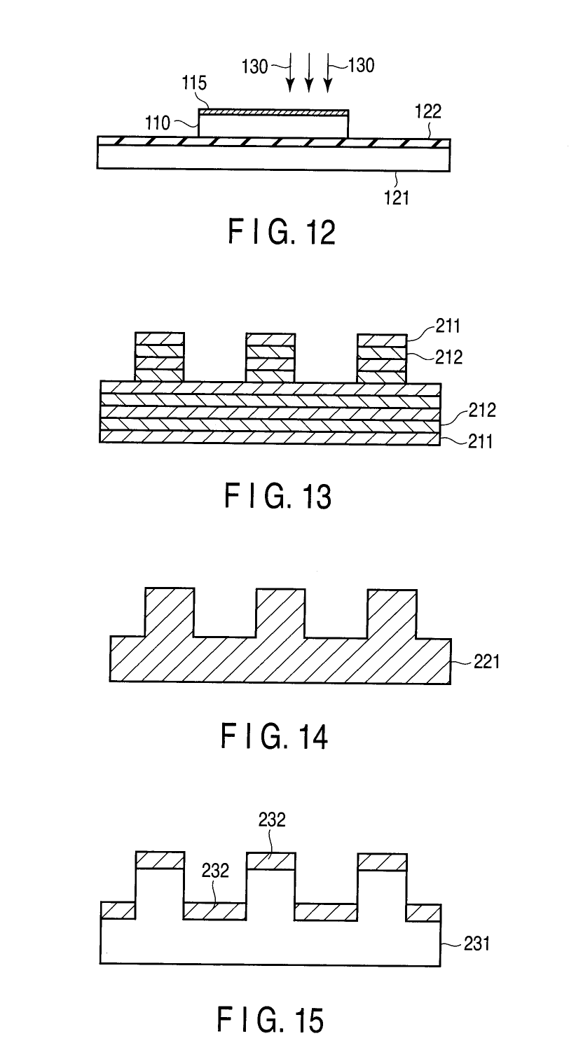

After the optimum irradiation position is determined as described above, the template 110 obtained in step S36 is used to perform optical nano-imprinting (S38). That is, as shown in FIG. 12, the template 110 is pressed against a nano-imprint material layer 122 formed on a semiconductor substrate (semiconductor wafer) 121. The element pattern of the template 110 is thus transferred to the nano-imprint material layer 122. A photosensitive resin that is sensitive to ultraviolet light (UV light) is used as the nano-imprint material layer 122. The optical nano-imprinting performed in the present process will be specifically described below.

First, the template 110 is aligned with the semiconductor substrate 121 and then pressed against the nano-imprint material layer 122 on the semiconductor substrate 121. In this state, the template 110 is irradiated with irradiation light 130 such as infrared light. That is, the light irradiation position determined in step S37 is locally irradiated with irradiation light 130. Since the light absorbing portion 115 is provided on the template 110, the temperature of the transparent substrate rises locally in the area irradiated with the irradiation light 130. As a result, the transparent substrate 111 expands locally to displace the element pattern of the template 110 to the regular position (intended element pattern position). With the position of the element pattern of the template 110 displaced as described above, the nano-imprint material layer 122 is irradiated with ultraviolet light via the template 110 to cure the nano-imprint material layer 122. After the nano-imprint material layer 122 is cured, the template 110 is separated from the nano-imprint material layer 122. In this manner, the element pattern formed on the template 110 is transferred to the nano-imprint material layer 122.

The photo-curing ultraviolet light may be applied to the nano-imprint material layer 122 after the irradiation with the irradiation light 130 such as infrared light is completed or during the irradiation with the irradiation light. Alternatively, before the template 110 is pressed against the nano-imprint material layer 122, the light absorbing portion may have been irradiated with the irradiation light 130 such as infrared light to raise the temperature of the light absorbing portion. In this case, after the irradiation with the irradiation light 130 is completed, the template 110 may be pressed against the nano-imprint material layer 122. That is, the temperature of the template 110 has only to be set to a desired value when the nano-imprint material layer 122 is irradiated with ultraviolet light and thus cured. Thus, in general, the light absorbing portion can be irradiated with the irradiation light 130 before or during the transfer of the element pattern to the nano-imprint material layer 122.

As described above, in the present embodiment, the light absorbing portion 115 is provided on the template 110 and locally irradiated with the irradiation light 130. Thus, the element pattern can be displaced to the appropriate position by means of the thermal expansion based on the light absorption by the light absorbing portion 115. Consequently, even if the position of the element pattern formed on the template deviates from that of the intended element pattern, the imprinting can be performed with the element pattern displaced to the appropriate position (intended element pattern position). As a result, the positional accuracy of the element pattern transferred to the nano-imprint material layer can be improved.

Furthermore, in the present embodiment, the irradiation light 130 is locally applied based on the location of the element pattern 113. Thus, even when the light absorbing portion 115 is formed on the entire area (all over the surface) of the template 110, the appropriate area of the template 110 can be heated. Thus, the element pattern can be displaced to the appropriate position without the need to locally form the light absorbing portion 115.

In the above-described first and second embodiments, infrared rays are used as irradiation light to raise the temperature of the light absorbing portion 115. However, light other than the infrared rays may be used. In general, preferably, the light can be efficiently absorbed by the light absorbing portion 115, and the photosensitive resin of the nano-imprint material layer 122 is insensitive to the light. Furthermore, in the above-described first and second embodiments, ultraviolet rays are used as light to which the photosensitive resin of the nano-imprint material layer 122 is exposed. However, light other than the ultraviolet rays may be used.

### Embodiment 3

The present embodiment relates to a template (mold) used for the nano-imprinting method, and in particular, to a template with a configuration suitable for inspections.

In the nano-imprinting method, an element pattern of a template is transferred to a nano-imprint material layer (photosensitive resin layer) intact. Thus, the element pattern of the template needs to be accurately and reliably inspected. Pattern inspections for the template are normally performed by irradiating the pattern formation surface of the template with charged particles such as electron beams. However, a transparent substrate (glass substrate) used for the template has insulating properties. Thus, the irradiation with the charged particles may result in charge-up. As a result, the resolution of an image obtained may be affected, making accurate and reliable inspections difficult. The present embodiment is adapted to solve these problems.

In the present embodiment, at least the surface area of the template is conductive and translucent. Thus, since at least the surface area of the template is conductive, the possible charge-up can be prevented when the front surface (pattern formation surface) of the template is irradiated with the charged particles such as electron beams for pattern inspections. Consequently, accurate inspections can be reliably performed. The conductive area is translucent, that is, the conductive area allows light (for example, ultraviolet light) used for photo-curing of the nano-imprint material layer (photosensitive resin layer) during imprinting to be pass through. Thus, the conductive area is prevented from blocking light, allowing the nano-imprint material layer to be reliably cured.

FIG. 13 is a sectional view schematically showing the configuration of the surface area of a template according to a first example of the present embodiment.

In the example shown in FIG. 13, at least the surface area of the template has a translucent stack structure of a semiconductor film (for example, a silicon film) 211 and a metal film (for example, a molybdenum film) 212. The translucent stack structure prevents possible charge-up during pattern inspections to allow accurate pattern inspections to be reliably performed. Furthermore, the present configuration allows the nano-imprint material layer to be reliably cured without blocking the photo-curing light. That is, the conductivity of the stack structure of the semiconductor film 211 and the metal film 212 allows the possible charge-up to be reliably prevented. Additionally, appropriately setting the film thicknesses of the semiconductor film 211 and metal film 212 allows the transmitted light to be inhibited from attenuating, based on an interference effect. Thus, the nano-imprint material layer can be reliably cured.

FIG. 14 is a sectional view schematically showing the configuration of the surface area of a template according to a second example of the present embodiment.

In the example shown in FIG. 14, at least the surface area of the template is formed of a translucent conductive oxide (for example, titanium oxide) 221. The translucent conductive oxide prevents possible charge-up during pattern inspections to allow accurate pattern inspections to be reliably performed. Furthermore, the present configuration allows the nano-imprint material layer to be reliably cured without blocking the photo-curing light.

FIG. 15 is a sectional view schematically showing the configuration of the surface area of a template according to a third example of the present embodiment.

In the example shown in FIG. 15, a translucent conductive ion implantation layer 232 is formed at least in the surface area of a template formed of a transparent substrate 231 such as quartz glass. For example, a gallium ion implantation layer may be used as the ion implantation layer 232. The translucent conductive ion implantation layer 232 prevents possible charge-up during pattern inspections to allow accurate pattern inspections to be reliably performed. Furthermore, the present configuration allows the nano-imprint material layer to be reliably cured without blocking the photo-curing light.

### Embodiment 4

The present embodiment relates to an alignment mark for a template (mold) used for the nano-imprinting method.

The template is aligned with a semiconductor substrate (semiconductor wafer) by irradiating an alignment mark formed on the semiconductor substrate and an alignment mark formed on the template with alignment light such as halogen light and observing reflected light. However, a nano-imprint material layer (photosensitive resin layer) and a transparent substrate (quartz glass substrate or the like) used for the template are transparent. Thus, obtaining sufficient contrast is difficult. In particular, the refractive index of the nano-imprint material layer is close to that of the transparent substrate (quartz glass substrate). Thus, when a groove for the alignment mark is filled with the nano-imprint material, obtaining sufficient contrast is more difficult. The present embodiment is adapted to solve these problems.

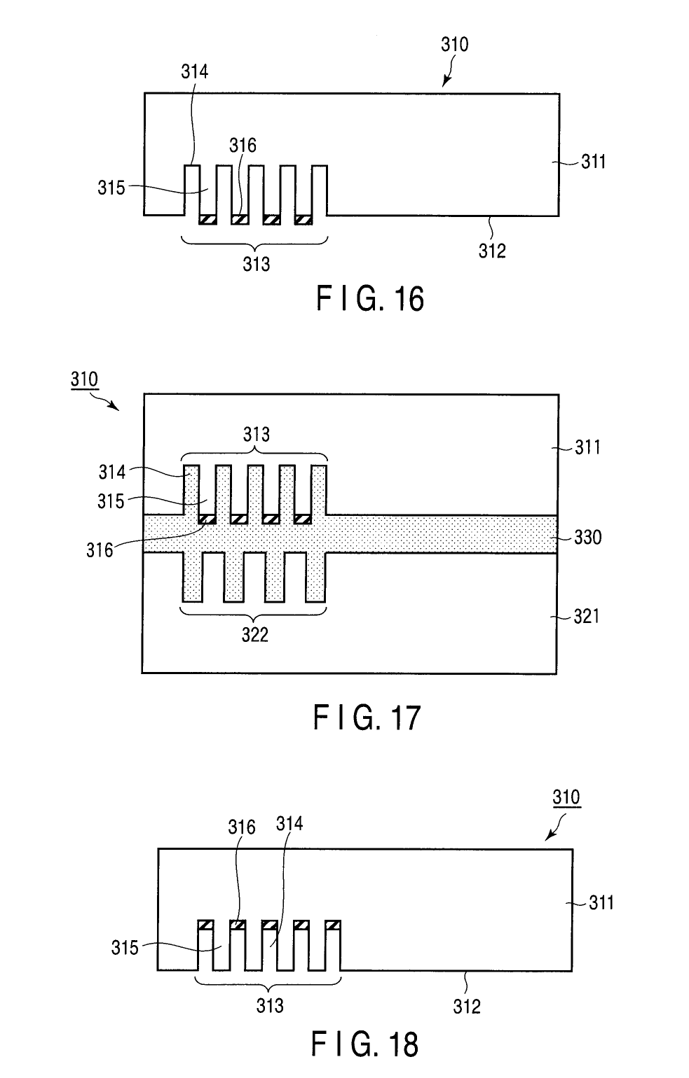

FIG. 16 is a sectional view schematically showing the configuration of a template according to the present embodiment.

The main body of a template 310 is composed of a transparent substrate 311 such as quartz glass. A nano-imprinting element pattern (not shown in the drawings) and an alignment mark 313 are formed on the front surface (pattern formation surface 312) of the transparent substrate 311. The alignment mark 313 has recess portions (groove portions) 314 and protruding portions 315. A half tone film 316 is formed on the tip surface of each of the protruding portions 315. The half tone film 316 is translucent to alignment mark detection light (for example, ultraviolet light) and to light (for example, ultraviolet light) used to photo-cure a nano-imprint material layer during imprinting.

FIG. 17 is a diagram schematically showing how alignment is performed using the template shown in FIG. 16.

As shown in FIG. 17, a nano-imprint material layer (photosensitive resin layer) 330 is interposed between an alignment mark 322 formed on a semiconductor substrate (semiconductor wafer) 321 and an alignment mark 313 formed on the template 310. The recess portions (groove portions) 314 are filled with the nano-imprint material layer. Thus, if the half tone film 316 is not provided, sufficient contrast is prevented from being obtained, making the alignment difficult.

In the present embodiment, the half tone film 316 is provided on the tip surface of the protruding portion 315 of the alignment mark 313. Thus, sufficient contrast can be obtained, and the alignment mark 313 of the template 310 can be reliably observed. Furthermore, the alignment mark 322, formed on the semiconductor substrate 321, can also be reliably observed. Consequently, the alignment can be reliably and easily performed. Additionally, the half tone film 316 is translucent to the light (for example, ultraviolet light) used to photo-cure the nano-imprint material layer. Thus, the nano-imprint material layer can be reliably photo-cured. Therefore, the present embodiment enables both the alignment and the photo-curing of the nano-imprint material layer to be reliably performed.

FIG. 18 is a sectional view schematically showing the configuration of a template according to a modification of the present embodiment. The basic configuration of the template according to the modification is similar to that shown in FIG. 16. In the template shown in FIG. 16, the half tone film 316 is provided on the tip surface of the protruding portion 315. In the modification, the half tone film 316 is provided on the bottom surface of each of the recess portions 314. Even this configuration enables effects similar to those of the template shown in FIG. 16 to be exerted.

The first to fourth embodiments of the present invention have been described. The matters described in the first to fourth embodiments may be appropriately combined together.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A template comprising:
a substrate;
an element pattern formed on a surface of the substrate; and
a light absorbing portion formed on or inside the substrate.

2. The template according to claim 1, wherein the light absorbing portion is locally provided on or inside the substrate.

3. The template according to claim 2, wherein the light absorbing portion is locally provided based on an arrangement of the element pattern.

4. The template according to claim 2, wherein the light absorbing portion is locally provided based on a pattern occupancy ratio of the element pattern.

5. The template according to claim 1, wherein the light absorbing portion exhibits higher light absorptivity than the substrate.

6. The template according to claim 1, wherein the light absorbing portion is formed of a metal film.

7. The template according to claim 1, wherein the light absorbing portion is a part of the substrate which has a reduced light transmittance.

8. A pattern forming method comprising:
preparing the template according to claim 1;
pressing the template against an imprint material layer to transfer the element pattern to the imprint material layer,
wherein before or during transferring the element pattern to the imprint material layer, the light absorbing portion is irradiated with irradiation light to thermally expand the template to displace a position of the element pattern.

9. The method according to claim 8, wherein the light absorbing portion is locally provided on or inside a substrate of the template.

10. The method according to claim 9, wherein an entire area of the template is irradiated with the irradiation light.

11. The method according to claim 9, wherein the light absorbing portion is locally provided based on an arrangement of the element pattern.

12. The method according to claim 9, wherein the light absorbing portion is locally provided based on a pattern occupancy ratio of the element pattern.

13. The method according to claim 8, wherein the light absorbing portion is provided at an entire area of the substrate in a direction parallel to a surface of the substrate.

14. The method according to claim 13, wherein the template is locally irradiated with the irradiation light.

15. The method according to claim 8, wherein the light absorbing portion exhibits higher light absorptivity than the substrate.

16. The method according to claim 8, wherein the light absorbing portion is formed of a metal film.

17. The method according to claim 8, wherein the light absorbing portion is a part of the substrate which has a reduced light transmittance.
